(19) United States
(12) Patent Application Publication
(10) Pub. No.: US 2008/0054724 A1
(43) Pub. Date: Mar. 6, 2008

(54) Method and system for improved power distribution in a semiconductor device through use of multiple power supplies

(76) Inventors: Eiichi Hosomi, Austin, TX (US); Satoru Takase, Austin, TX (US)

Correspondence Address: SPRINKLE IP LAW GROUP, 1301 W. 25TH STREET, SUITE 408, AUSTIN, TX, 78705, US

(21) Appl. No.: 11/515,656

(22) Filed: Sep. 5, 2006

(51) Int. Cl. H02J 1/00

(52) U.S. Cl. 307/69

(57) ABSTRACT

Systems, methods and apparatuses which may be capable of achieving better voltage distribution within a voltage domain are disclosed. Embodiments of the present invention may provide a power distribution network capable of achieving a flatter voltage distribution throughout a voltage domain to which the power distribution network is coupled. More specifically, a power distribution network may comprise multiple power supplies and voltage sensors, each power supply operable to provide power to the voltage domain. A power supply may supply voltage to the voltage domain while one or more additional power supplies may supply power to the voltage domain in the vicinity of a voltage sensor based on the voltage sensed at the voltage sensor. In this way, voltage fluctuation across a voltage domain may be reduced without significantly increasing the power consumption of the semiconductor device.

### TECHNICAL FIELD OF THE INVENTION

The invention relates in general to methods and systems for semiconductor devices, and more particularly, to utilizing multiple power supplies to improve the power distribution in semiconductor devices.

### BACKGROUND OF THE INVENTION

With the advent of the computer age, electronic systems have become a staple of modern life, and some may even deem them a necessity. Part and parcel with this spread of technology comes an ever greater drive for more functionality from these electronic systems. A microcosm of this quest for increased functionality is the size and capacity of various semiconductor devices. From the 8 bit microprocessor of the original Apple I, through the 16 bit processors of the original IBM PC AT, to the current day, the processing power of semiconductors has grown while the size of these semiconductors has consistently been reduce. In fact, Moore's law recites that the number of transistors on a given size piece of silicon will double every 18 months.

As semiconductors have evolved into these complex systems, almost universally the connectivity and power requirements for these semiconductors have been increasing. In fact, the higher the clock frequency utilized with a semiconductor, the greater that semiconductor's power consumption (all other aspects being equal). Part and parcel, however, with the increase in power consumption and operating frequency is the countervailing tendency toward reduced operating voltages in semiconductors and thus, tighter noise budgets. As can be seen then, these requirements may be at odds with one another to a certain extent. In particular, increasing the power consumption of a semiconductor device usually results in more switching noise, which is less than desirable given a tighter noise budget.

In order to ameliorate the dichotomy between these various opposing requirements and desires, actual voltage at a semiconductor device may be tightly controlled. More particularly, areas of a semiconductor device may be divided into voltage domains (e.g. groupings of circuitry utilized for similar functionality, circuitry within a certain distance, etc.) In many cases, a power distribution network regulates power to a voltage domain within the semiconductor device based at least in part upon the actual voltage sensed in the voltage domain. This voltage may be sensed using a voltage sensor on the semiconductor device.

The voltage sensed by this voltage sensor, however, is heavily dependent on the placement of the voltage sensor. This dependency is based in no small part on the possible voltage gradients which may exist in the voltage domain. These voltage gradients may be caused by a DC drop in the package substrate of the semiconductor device or printed circuit board on which the semiconductor device is included, the operation of the semiconductor device, or a myriad number of other causes. A voltage gradient in voltage domain naturally means that there will be some difference between the minimum and maximum voltages in the voltage domain, and, in most cases, the output from the voltage sensor will only represent the voltage of the area of the voltage domain near the voltage sensor. This discrepancy between the voltage measured and the actual voltage on, or across, the voltage domain may hamper the ability of a power distribution network to regulate power to the semiconductor device.

Typically, a single power supply may be used to supply voltage to a voltage domain. Thus, a single voltage may be supplied to a voltage domain based solely upon the voltage measured by the single voltage sensor. This methodology, coupled with variations in local power consumption throughout a single voltage domain may cause a significant degree of voltage fluctuation throughout the voltage domain. These voltage fluctuations may, in turn have a detrimental effect on the functioning of the circuitry within the voltage domain, impairing the performance of the semiconductor device and possibly leading to malfunction of the semiconductor device itself

Thus, what is desired are improved systems and methods for more accurately regulating the power to a semiconductor device, or voltage domain of a semiconductor device, such that a more uniform voltage distribution on, or across, a semiconductor device or voltage domain may be achieved.

### SUMMARY OF THE INVENTION

Systems, methods and apparatuses which may be capable of achieving better voltage distribution within a voltage domain are disclosed. Embodiments of the present invention may provide a power distribution network capable of achieving a flatter voltage distribution throughout a voltage domain to which the power distribution network is coupled. More specifically, a power distribution network may comprise multiple power supplies and voltage sensors, each power supply operable to provide power to the voltage domain. A power supply may supply voltage to the voltage domain while one or more additional power supplies may supply power to the voltage domain in the vicinity of a voltage sensor based on the voltage sensed at the voltage sensor. In this way, voltage fluctuation across a voltage domain may be reduced without significantly increasing the power consumption of the semiconductor device.

In one embodiment, a two power supplies may provide power to a voltage domain of a semiconductor device based on voltages sensed at voltage sensors.

In another embodiment, one power supply may provide power based on a voltage sensed at one voltage sensor while the other power supply may provide power based on the voltage sensed at another voltage sensor.

In some embodiments, the other power supply may supply additional power in the vicinity of the voltage sensor to compensate for a voltage drop.

In other embodiments, the other power supply may supply power through a section of a plane which is coupled in the vicinity of the voltage sensor or an area of the voltage domain in the vicinity of the voltage sensor.

In some embodiments, the representative voltage signal may be generated by taking an average of the sensed voltages or a maximum of the sensed voltages.

Embodiments of the present invention may allow the power delivered to a semiconductor die to be more accurately regulated by providing a more accurate measurement of the voltage or voltages on a semiconductor die. These more accurate measurements may allow for power regulation methodologies that take into account voltage gradients or differentials across, or on, a semiconductor device and therefore better control the delivery of power based on these measured voltage.

Additionally, embodiments of the present invention offer the advantage that a voltage drop within a voltage domain may be compensated for, allowing a semiconductor device to operate substantially at a desired operating speed without a significant increase in the power consumption of the semiconductor device.

Furthermore, as any additional power supplies may not be needed to provide the entire voltage requirements of a voltage domain the impact of having more than a single power supply providing power to a voltage domain on cost and physical factors (e.g. line width and the area of the package) may be reduced.

These, and other, aspects of the invention will be better appreciated and understood when considered in conjunction with the following description and the accompanying drawings. The following description, while indicating various embodiments of the invention and numerous specific details thereof, is given by way of illustration and not of limitation. Many substitutions, modifications, additions or rearrangements may be made within the scope of the invention, and the invention includes all such substitutions, modifications, additions or rearrangements.

### BRIEF DESCRIPTION OF THE DRAWINGS

The drawings accompanying and forming part of this specification are included to depict certain aspects of the invention. A clearer impression of the invention, and of the components and operation of systems provided with the invention, will become more readily apparent by referring to the exemplary, and therefore nonlimiting, embodiments illustrated in the drawings, wherein identical reference numerals designate the same components. Note that the features illustrated in the drawings are not necessarily drawn to scale.

FIG. 1 depicts a block diagram of one embodiment of portions of a power distribution network for providing power to a semiconductor device.

FIG. 2A depicts a cutaway diagram of one embodiment of a semiconductor package coupled to a printed circuit board.

FIGS. 2B and 2C depict two examples of voltage gradients which may exits across semiconductor dies during operation of those dies.

FIG. 3 depicts a block diagram of one embodiment of portions of a power distribution network for providing power to a semiconductor device with multiple voltage sensors.

FIG. 4 depicts a block diagram of one embodiment of a semiconductor device with multiple voltage sensors.

FIG. 5 depicts a block diagram of one embodiment of portions of a power distribution network for providing power to a semiconductor device with multiple voltage sensors.

FIG. 6 depicts a block diagram of one embodiment of a semiconductor device with multiple voltage sensors.

FIG. 7 depicts a block diagram of one embodiment of a semiconductor device with multiple voltage sensors.

FIG. 8 depicts a block diagram of one embodiment of a semiconductor device with multiple voltage sensors and a power distribution network for providing power to a semiconductor device with multiple voltage sensors.

FIG. 9 depicts a block diagram of one embodiment of a semiconductor device with multiple voltage sensors and a power distribution network for providing power to a semiconductor device with multiple voltage sensors.

FIGS. 10A, 10B and 10C depicts a block diagram of embodiments of a semiconductor device with multiple voltage sensors and a power distribution network for providing power to a semiconductor device with multiple voltage sensors.

FIG. 11 depicts a block diagram of one embodiment of a semiconductor device with multiple voltage sensors and a power distribution network for providing power to a semiconductor device with multiple voltage sensors.

FIG. 12 depicts a block diagram of one embodiment of a semiconductor device with multiple voltage sensors and a power distribution network for providing power to a semiconductor device with multiple voltage sensors.

FIG. 13 depicts a block diagram of one embodiment of a semiconductor device with multiple voltage sensors and a power distribution network for providing power to a semiconductor device with multiple voltage sensors.

### DETAILED DESCRIPTION

The invention and the various features and advantageous details thereof are explained more fully with reference to the nonlimiting embodiments that are illustrated in the accompanying drawings and detailed in the following description. Descriptions of well known starting materials, processing techniques, components and equipment are omitted so as not to unnecessarily obscure the invention in detail. Skilled artisans should understand, however, that the detailed description and the specific examples, while disclosing preferred embodiments of the invention, are given by way of illustration only and not by way of limitation. Various substitutions, modifications, additions or rearrangements within the scope of the underlying inventive concept(s) will become apparent to those skilled in the art after reading this disclosure.

Reference is now made in detail to the exemplary embodiments of the invention, examples of which are illustrated in the accompanying drawings. Wherever possible, the same reference numbers will be used throughout the drawings to refer to the same or like parts (elements).

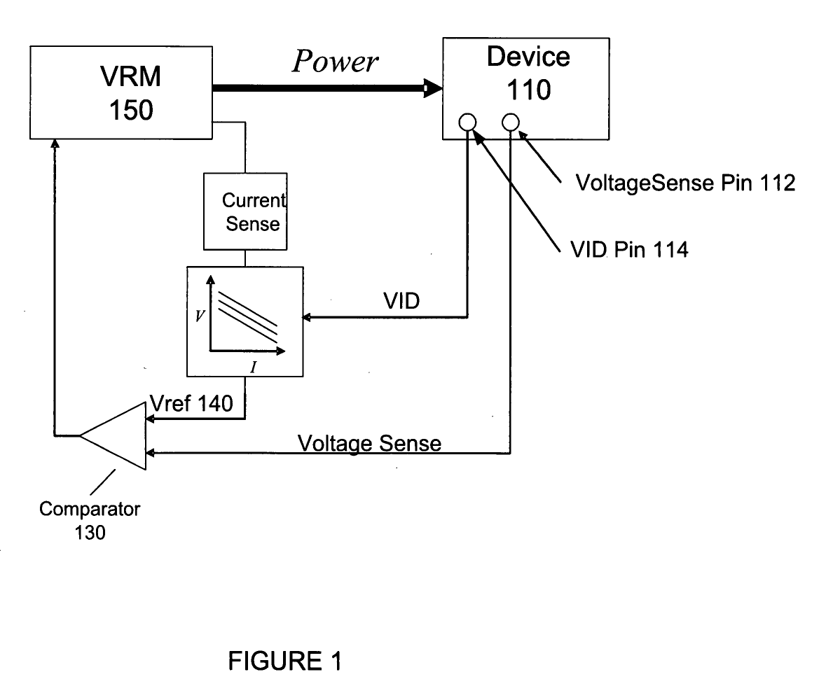

Before describing embodiments of the present invention it may be useful to describe an exemplary architecture for a power distribution network which is operable to control the power to a semiconductor device. FIG. 1 depicts a block diagram of a portion of one example of just such a power distribution network. Semiconductor device 110 may comprise a semiconductor die (not shown) and a substrate or package. The die may be an integrated circuit, such as a microprocessor, coupled to a package which may serve to couple the die to a power source or other signal lines. Typically, the substrate with which microprocessors or semiconductors are packaged is made of organic material (such as epoxy resin) and may be fabricated using build-up technology such that a substrate comprising the package may comprise a set of planes (which may be referred to as package planes).

Semiconductor device 110 may comprise two outputs: a voltage identification (VID) output 114 and a voltage (Vdd) sensed output 112. Each of these outputs may be one or more pins on the package of semiconductor device 110; the VID output 114 operable to provide one or more setting which define the voltage required by the die of semiconductor device 110 and the Vdd output 112 operable to provide a signal representing a voltage sensed on the die of device 110 by a voltage sensor.

Vdd sense pin 112 may be coupled to an input of comparator 130, which also receives as input voltage reference signal 140. Comparator 130 provides an output representing the difference between the signal received from Vdd sense pin 112 and the voltage reference signal 140. Voltage regulator module (VRM) 150 receives this differential signal as an input and is operable to regulate the power provided to device 110 based on this differential signal.

More particularly, in one embodiment, during operation of the portion of the power distribution network depicted in FIG. 1 the power to device 110 may be regulated using a technique called droop control. Thus, it is desired that output voltage from VRM 150 is decreased as output current from VRM 150 is increased. To implement this type of power control, in one embodiment the slope of the current-voltage (I-V) curve utilized by the power distribution network may be the same for different VID settings, but the intercept utilized in conjunction with the I-V curve depends on the VID setting.

Consequently, during operation of the power distribution network the VID setting may be used in conjunction with the sensed current output of VRM 150 to determine an appropriate reference voltage and this reference voltage is provided to comparator 130. Comparator 130 compares this references voltage on input 140 to the sensed voltage signal on the input coupled to Vdd sense pin 112 and provides a signal representing the difference between these two inputs to VRM 150, which, in turn, regulates the power to device 110 based on this differential signal.

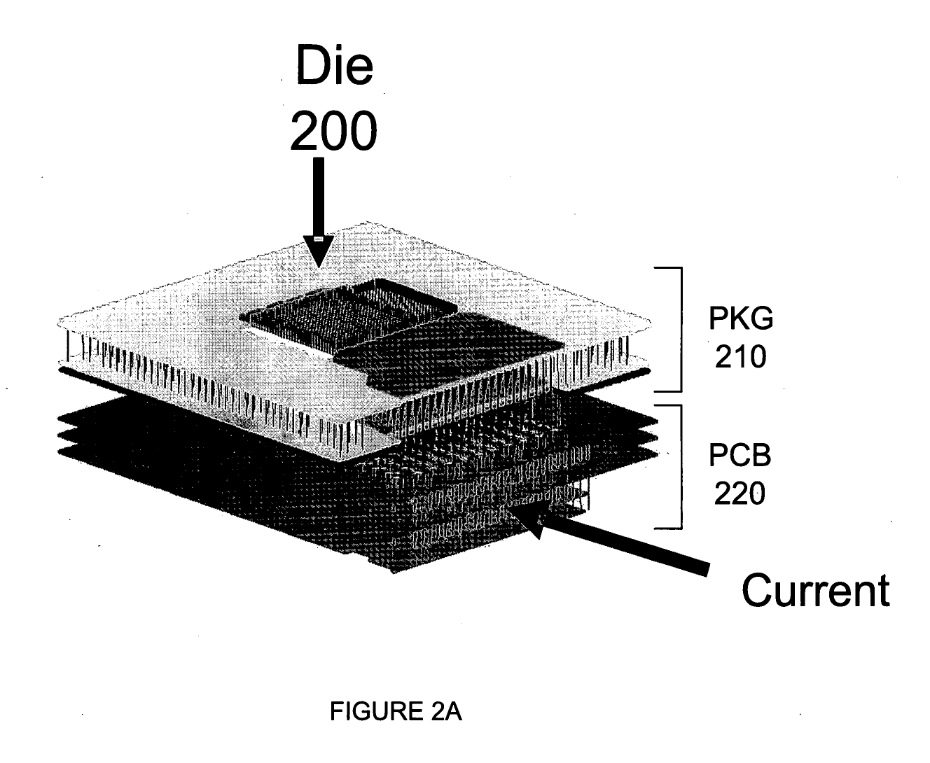

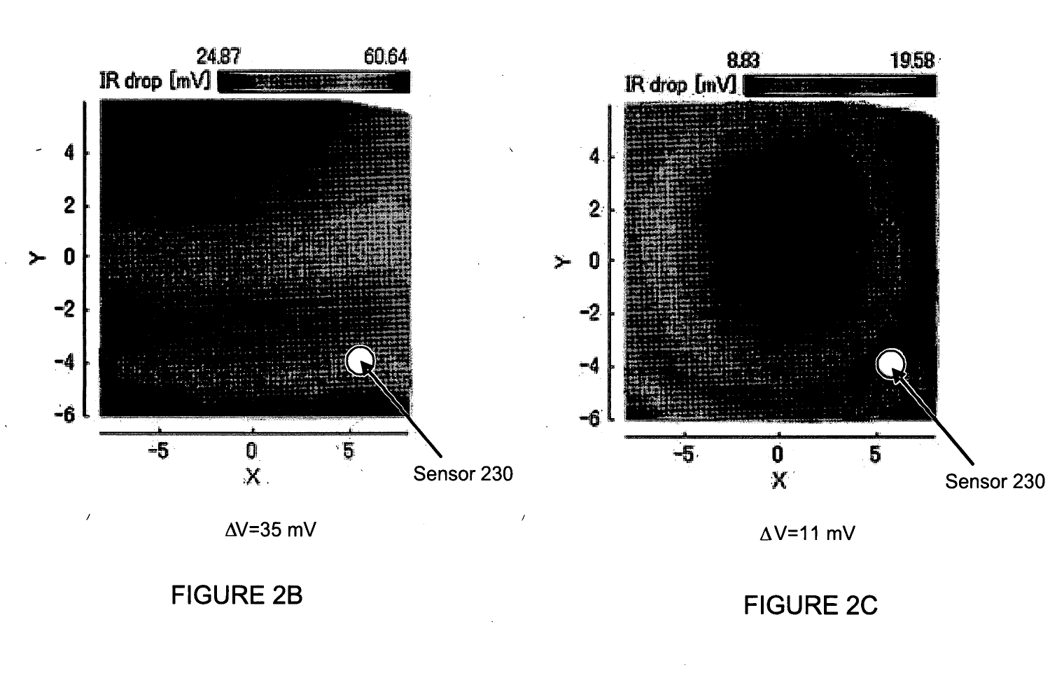

Typically, however, the die of device 110 has only one voltage sensor. This arrangement may be problematic as may be better explained with reference to FIGS. 2A, 2B and 2C. FIG. 2A depicts one embodiment of semiconductor device 110 comprising die 200 and package 210. In many instances, when semiconductor device 110 is utilized in an operational capacity it is coupled to printed circuit board (PCB) 220. Current can then be provided from a power supply such as VRM 150 to die 200 via PCB 220 and package 210.

Due to a variety of circumstances, including DC drop in the package substrate of package 210 of device 110 and PCB 220 to which device 110 is usually coupled, a voltage gradient may be extant on die 200 of device 110 during operation of semiconductor device 110. It will be apparent that the voltage distribution across die 200 will depend on the design and construction of die 200 itself, package 210 with which die 200 is utilized and the configuration, design or construction of PCB 220, among myriad other variables. As a result of the voltage gradient on die 200 there may be a marked difference between the maximum or minimum voltage on die 200 and the voltage in the vicinity of a single voltage sensor present on die 200. Consequently, the voltage sensed at a voltage sensor, and thus the signal output at Vdd sense pin 112 may not accurately reflect the voltage across die 200, and may vary markedly based on the placement of the voltage sensor on die 200 (all other factors being equivalent).

FIG. 2B depicts a representation of the voltages in various parts of die 200 which may occur during one mode of operation of device 110. Notice that in FIG. 2B the voltage gradient across die 200 may be approximately 35 mV. Voltage sensor 230 may be placed in an area of die 200 where the voltage during this mode of operation is approximately 25 mV. The signal output on Vdd sense pin 112 may therefore reflect that the voltage on die 110 is approximately 25 mV. As can be seen from FIG. 2B, however, voltage in other areas of die 200 may be approximately 60 mV. Thus, the output of Vdd sense pin 112 does not accurately represent the voltage across the entire die 110.

This problem can be further illustrated with respect to FIG. 2C. FIG. 2C depicts a representation of the voltages in various parts of die 200 which may occur during another mode of operation of device 110. Notice that in FIG. 2C the voltage gradient across die 200 may be approximately 11 mV. Voltage sensor 230 may be placed in an area of die 200 where the voltage during this mode of operation is approximately 10 mV. The signal output on Vdd sense pin 112 may therefore represent that the voltage on die 110 is approximately 10 mV. As can be seen from FIG. 2C, however, voltage in other areas of die 200 may be approximately 19.5 mV. Thus, the output of Vdd sense pin 112 does not accurately represent the voltage across the entire die 110.

The discrepancy between the voltage sensed and the actual voltages occurring in different parts of die 110 can adversely affect the ability of a power control network to modulate or control power to a semiconductor device. Therefore, it is desired to provide a more accurate measurement of voltage across die 200 such that power to device 110 may be better controlled.

It may be helpful here to describe certain systems and methods for obtaining a more accurate measurement of the voltage on a die which may be used to help regulate power to a semiconductor device or a voltage domain. These systems and methods may utilize two or more voltage sensors on a die to obtain a set of voltages sensed at multiple locations. These sensed voltages may then be processed to create a representative voltage for the die. This representative voltage may then be used to control the power to the semiconductor device comprised by the die.

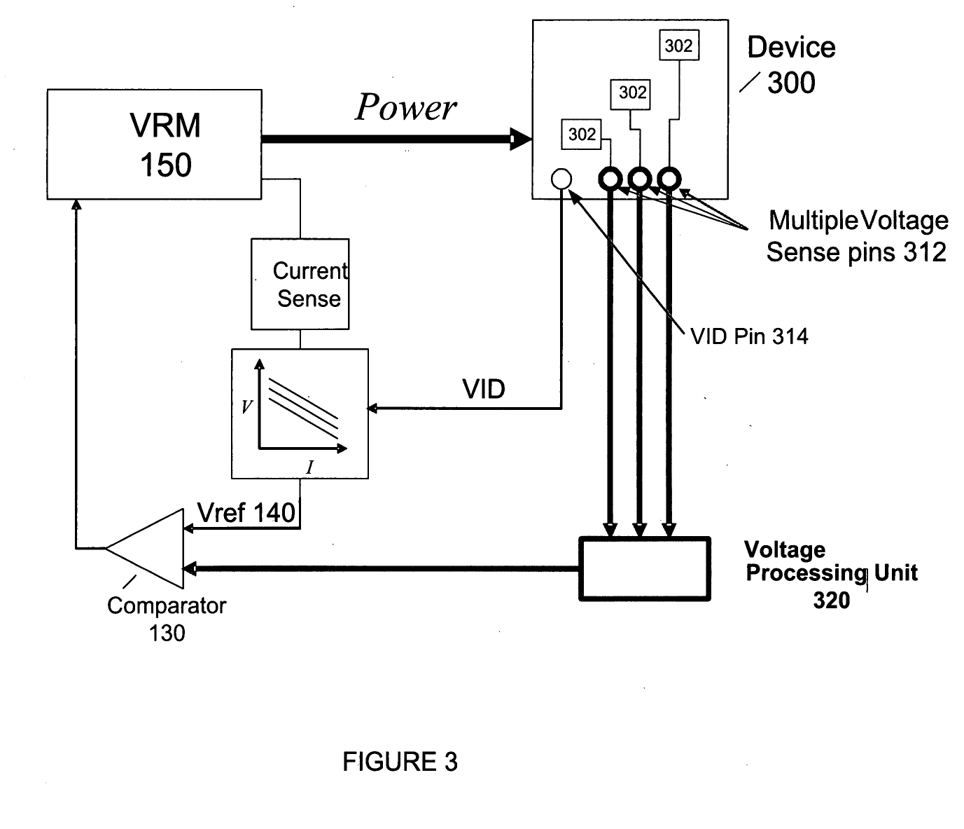

FIG. 3 depicts one embodiment of portions of a power distribution network which may be utilized in conjunction with one embodiment of a semiconductor device with multiple voltage sensors. More specifically, semiconductor device 300 may comprise a semiconductor die (not shown) and a substrate or package. Semiconductor device 300 may have a plurality of voltage sensors 302, each voltage sensor 302 operable to sense a voltage at a different location on the die of semiconductor device 300.

Semiconductor device 300 may comprise a set of output pins. In particular, semiconductor device 300 may have a voltage identification (VID) output pin 314 and a set of Voltage (Vdd) sense pins 312. The VID pin 314 is operable to provide one or more settings which define the voltage required or desired by the die of semiconductor device 300, while each of the Vdd sense pins 312 may be coupled to a voltage sensor 302 and operable to provide a signal representative of the voltage sensed by that voltage sensor 302.

Each of Vdd sense pins 312 may be coupled to an input of voltage processing unit (VPU) 320. In one particular embodiment, each Vdd sense pin 312 may be coupled to VPU 320 using two signal lines, where the difference in voltage between the two signal lines is approximately equal to the voltage sensed at voltage sensor 302 to which that Vdd sense pin 312 is coupled.

VPU 320 is operable to receive two or more signals representing sensed voltages at its inputs and create a representative voltage signal from these sensed voltage signals. This representative voltage signal may be created by averaging the signals representing the sensed voltages, taking the maximum of the signals representing the sensed voltages, or by another desired method.

The representative voltage signal from VPU 320 is provided to an input of comparator 130, which also receives as input voltage reference signal 140. Comparator 130 provides an output representing the difference between the representative voltage signal received from VPU 320 and voltage reference signal 140. Voltage regulator module (VRM) 150 receives this differential signal as an input and is operable to regulate the power provided to device 300 based on this differential signal.

More particularly, in one embodiment, it may be desirable to operate the power distribution network depicted in FIG. 3 using a technique called droop control, as discussed above. Consequently, during operation of the power distribution network the VID setting from VID pin 314 may be used in conjunction with a sensed current output of VRM 150 to determine an appropriate reference voltage. This reference voltage is provided to comparator 130. Comparator 130 compares this reference voltage to the representative voltage signal created by VPU 320 from each of the sensed voltages signals received from Vdd sense pins 312 and provides a signal indicating the difference between these two inputs to VRM 150, which, in turn, regulates the power to device 300 based on this differential signal.

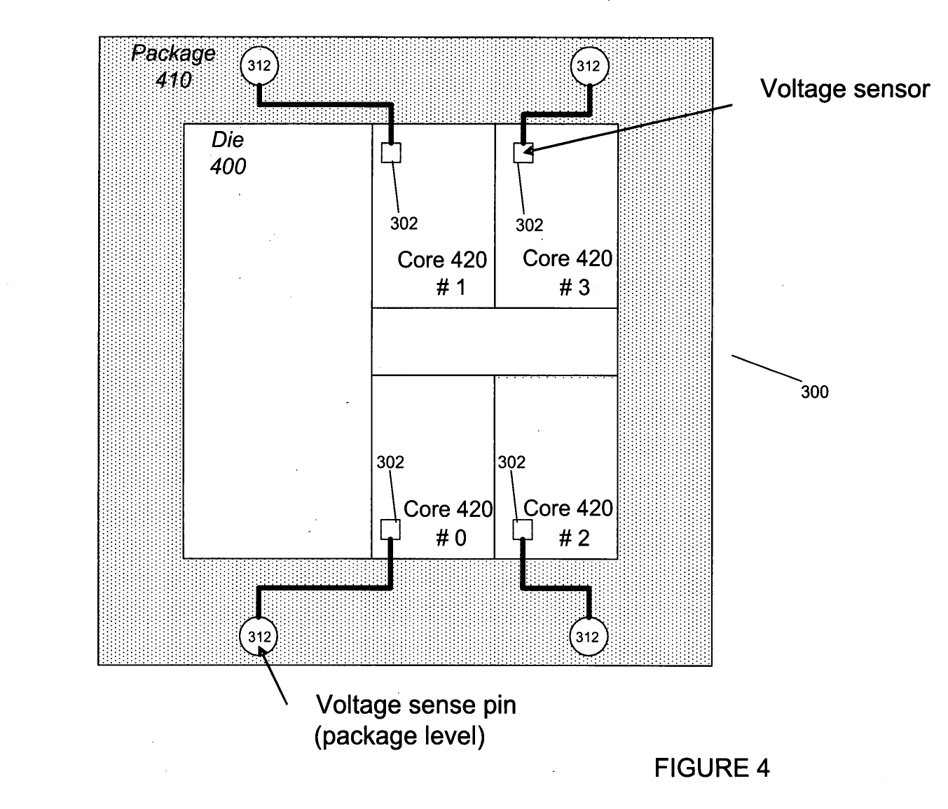

Turning now to FIG. 4, a schematic view of one embodiment of a die and package layout which may utilized to implement device 300 is depicted. Semiconductor device 300 comprises die 400 coupled to package 410. Die 400 may, in turn, comprise a set of processor cores 420. Each of processor cores 420 comprises a voltage sensor 302, where each of voltage sensors 302 may be coupled to a unique Vdd sense pin 312 on package 410. This may be accomplished by coupling voltage sensor 302 to its respective Vdd sense pin 312, in some embodiments by coupling voltage sensor 302 to an output pin of die 410 and coupling that output pin of die 410 to the respective Vdd sense pin 312.

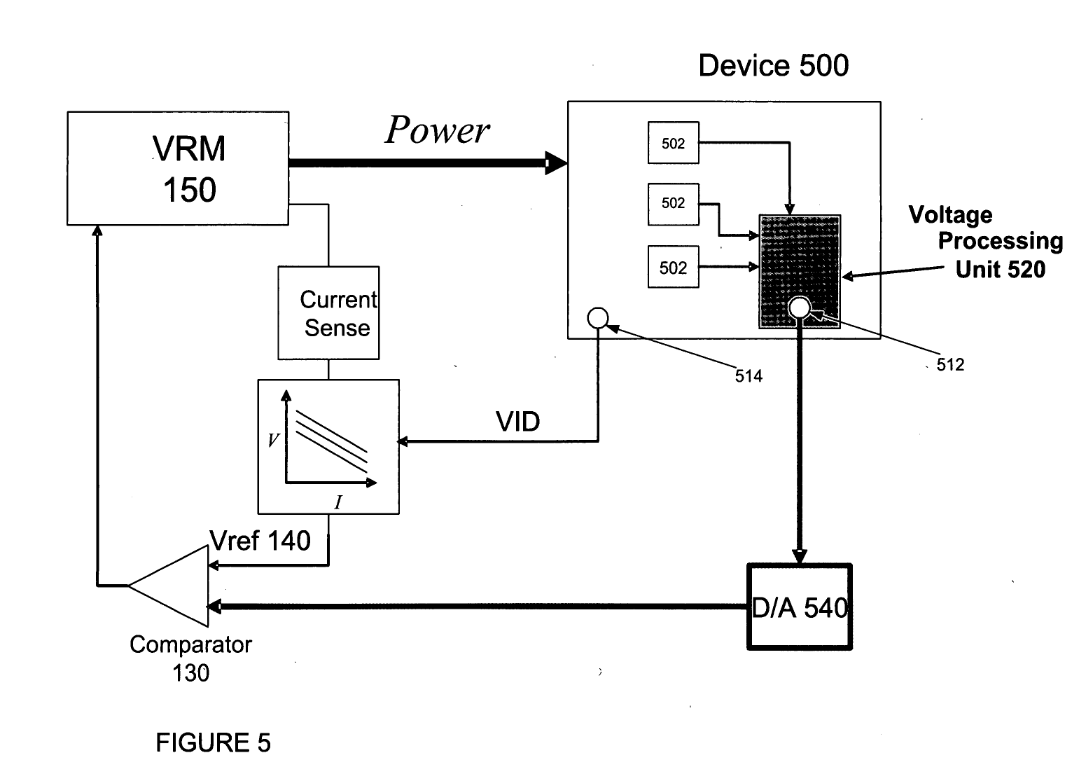

Moving on, FIG. 5 depicts another embodiment of portions of a power distribution network which may be utilized in conjunction with one embodiment of a semiconductor device with multiple voltage sensors. More specifically, semiconductor device 500 may comprise a semiconductor die (not shown) and a substrate or package. Semiconductor device 500 may comprise VPU 520 and a plurality of voltage sensors 502, each voltage sensor 502 operable to sense a voltage at a different location on the die of semiconductor device 500 and provide a signal representative of the sensed voltage to VPU 520.

VPU 520, which may be formed on the die of semiconductor device 500, is operable to receive signals representative of the sensed voltages from voltage sensors 502 and create a representative voltage signal from these sensed voltage signals. In one embodiment, voltage sensors 502 may generate an analog signal representative of the sensed voltage. This analog signal may be processed by VPU 520 and a digital representative voltage signal generated by VPU 520. More specifically, this may be accomplished by converting each of the received analog signals representative of sensed voltages to a corresponding digital signal at VPU 520 before processing. Alternatively, voltage sensor 502 may itself include a Analog-to-Digital (A/D) converter, and thus the analog signal representative of the sensed voltage may be converted to a digital signal and this digital signal representative of the sensed voltage provided to VPU 520.

VPU 520 may be coupled to Vdd sense pin 512 of device 500 such that the representative voltage signal produced by VPU 520 may be available at Vdd sense pin 512. Additionally, semiconductor device 500 may also have voltage identification (VID) output pin 514 operable to provide one or more settings which define the voltage required or desired by the die of semiconductor device 500.

In some cases, as the representative voltage signal provided at Vdd sense pin 512 is a digital signal, Vdd sense pin 512 may, in turn, be coupled to an input of Digital-to-Analog (D/A) converter 540 operable to convert the input digital representative voltage signal to an analog representative voltage signal. This analog representative voltage is provided to an input of comparator 130, which also receives as input voltage reference signal 140. Comparator 130 provides an output signal representing the difference between the analog representative voltage signal received from D/A converter 540 and voltage reference signal 140. Voltage regulator module (VRM) 150 receives this differential signal as an input and is operable to regulate the power provided to device 500 based on this differential signal.

More particularly, in one embodiment, it may be desirable to operate the power distribution network depicted in FIG. 5 using a technique called droop control, as discussed above. Consequently, during operation of the portions of the power distribution network depicted, the VID setting from VID pin 514 may be used in conjunction with a sensed current output of VRM 150 to determine an appropriate reference voltage. This reference voltage is provided to comparator 130. Comparator 130 compares this reference voltage to the analog representative voltage signal provided by D/A converter 540 and provides a signal representative of the difference between these two inputs to VRM 150, which, in turn, regulates the power to device 500 based on this differential signal.

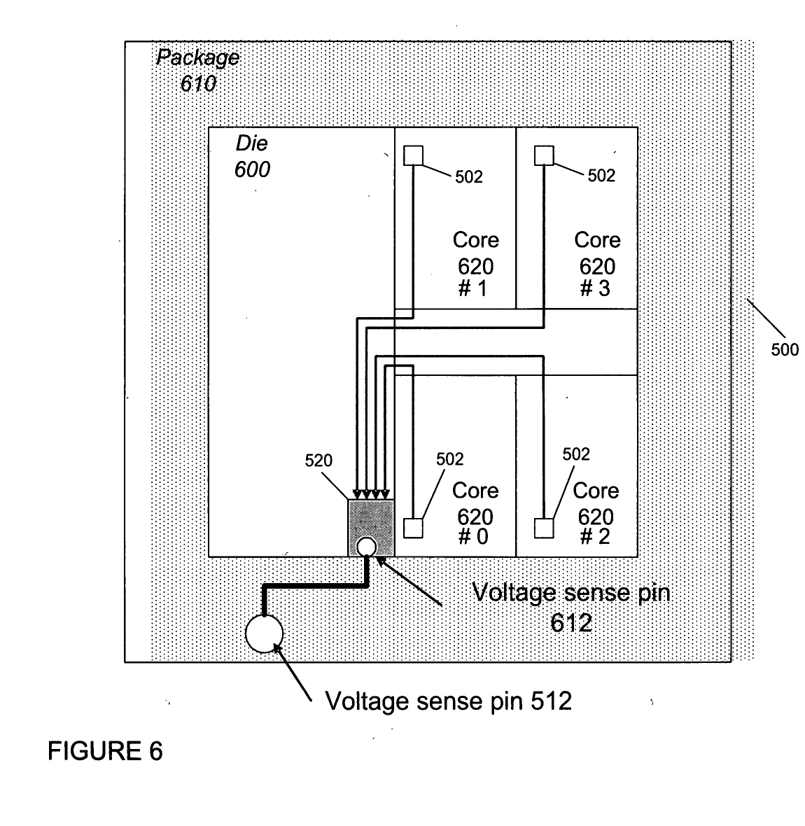

Turning now to FIG. 6, a schematic view of one embodiment of a die and package layout which may utilized to implement device 500 of FIG. 5 is depicted. Semiconductor device 500 comprises die 600 coupled to package 610. Die 600 may, in turn, comprise a set of processor cores 620 and VPU 520. Each of processor cores 620 comprises voltage sensor 502, where each of voltage sensors 502 may be coupled to VPU 520 on die 600. VPU 520, is, in turn, coupled to Vdd sense pin 512. This may be accomplished by coupling VPU 520 to a die level voltage level sense pin 612 and coupling this die level voltage sense pin 612 to Vdd sense pin 512 such that VPU 520 may provide a representative voltage signal to Vdd sense pin 512 though die level voltage sense pin 612. It can be seen then, that by placing VPU 520 on die 600 itself, a representative voltage signal can be provided external to package 610 using, if desired, a single pin on die 600 and a single pin on package 610.

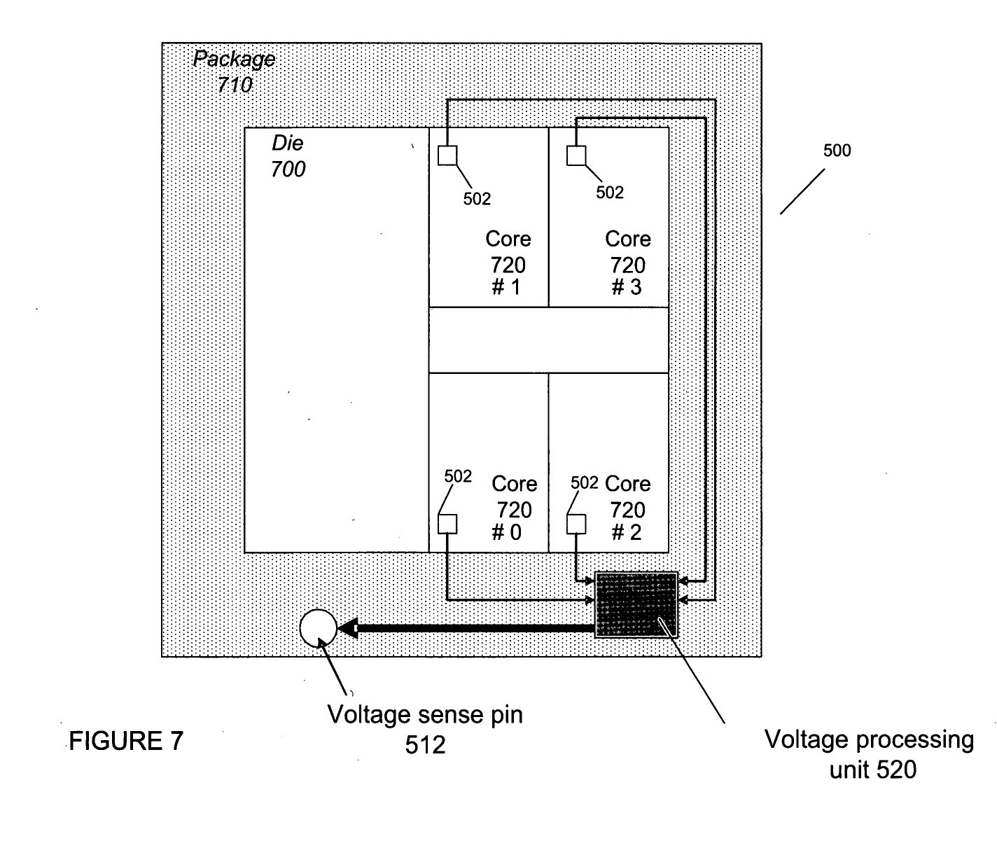

Turning now to FIG. 7, a schematic view of another embodiment of a die and package layout which may utilized to implement device 500 of FIG. 5 is depicted. Semiconductor device 500 comprises die 700 coupled to package 710. Die 700 may, in turn, comprise a set of processor cores 720. Package 710 may comprise VPU 520. In one embodiment, VPU 520 may be a die distinct from die 700 and may be coupled to package 710.

Each of processor cores 720 comprises voltage sensor 502, where each of voltage sensors 502 may be coupled to VPU 520 in package 710. VPU 520, is, in turn, coupled to Vdd sense pin 512. This may be accomplished by coupling each of voltage sensors 502 to VPU 520 using die level pins and coupling an output of VPU 520 to Vdd sense pin 512 such that VPU 520 may provide a representative voltage signal at Vdd sense pin 512. It can be seen then, that by utilizing a distinct die for VPU 520 and locating VPU 520 in package 710, a representative voltage signal can be provided using a single pin on package 710 without the need to form VPU 520 on die 710.

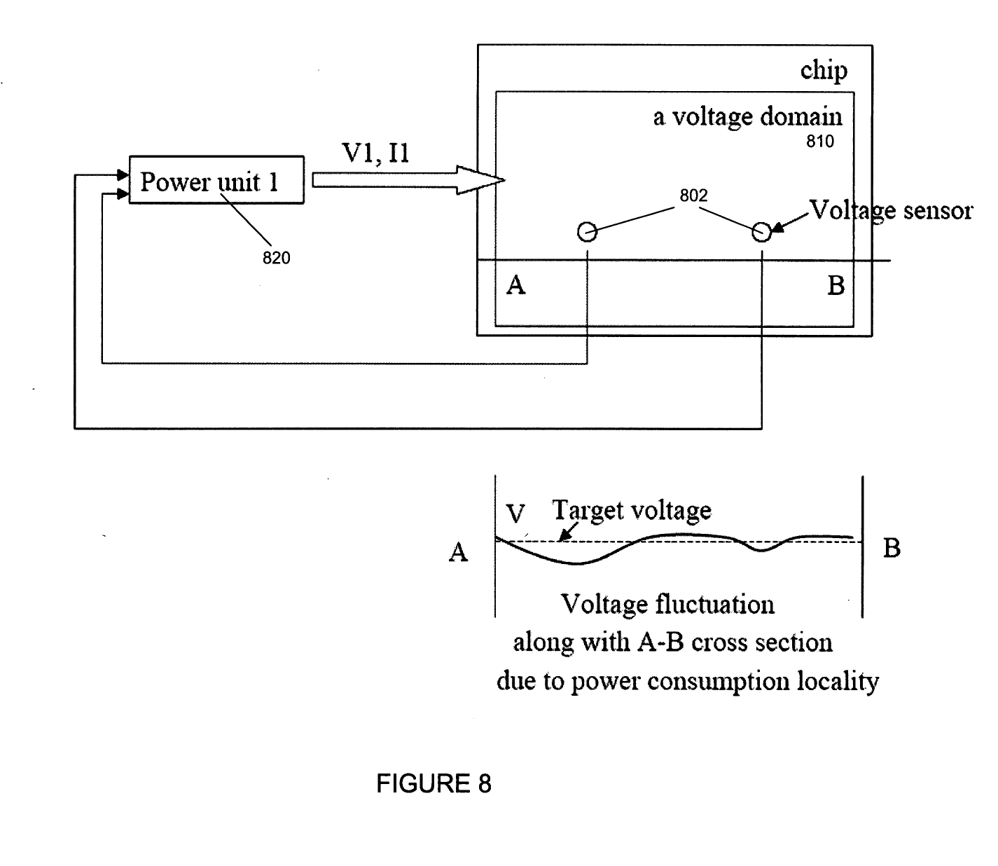

The systems and methods for controlling the power to a semiconductor device or a voltage domain described above are, however, not without there own set of problems. One of these problems may be illustrated more clearly with reference to FIG. 8, which illustrates one embodiment of a power distribution network utilizing a plurality of voltage sensors 802 to control the delivery of voltage from power supply 820 to voltage domain 810 (e.g. a processor core, circuitry with similar functionality, circuitry located within a certain area, etc.). It will be noted that the power distribution network depicted in FIG. 8 is exemplary only, and is depicted without regards to parts not discussed which may be included in the power distribution network such as certain planes, vias, BGA balls, pins, voltage processing units, voltage sensors, etc.

Notice, with respect to the embodiment of the power distribution network depicted in FIG. 8, that only a single power unit 820 is supplying voltage to voltage domain 810 based on the voltage sensed by the plurality of voltage sensors 802. In other words, substantially an average of the voltage sensed at plurality of voltage sensors 802 may be used to regulate the delivery of power to voltage domain 810 from power supply 820. As may be seen, embodiments of power distribution networks such as that depicted in FIG. 8 may be useful for better achieving a desired overall average voltage throughout voltage domain 810. However, because the voltage is regulated from a single power supply based on an approximately average voltage determined from a set of voltages sensed at a plurality of locations, power distribution networks such as these may do little to ameliorate the size of voltage fluctuations or gradients throughout voltage domain 810, as may be desired.

Attention is now directed to systems, methods and apparatuses which may be capable of achieving better voltage distribution within a voltage domain. Embodiments of the present invention may provide a power distribution network capable of achieving a flatter voltage distribution throughout a voltage domain to which the power distribution network is coupled. More specifically, a power distribution network may comprise multiple power supplies and voltage sensors, each power supply operable to provide power to the voltage domain. A power supply may supply voltage to the voltage domain while one or more additional power supplies may supply power to the voltage domain in the vicinity of a voltage sensor based on the voltage sensed at the voltage sensor. In this way, voltage fluctuation across a voltage domain may be reduced without significantly increasing the power consumption of the semiconductor device.

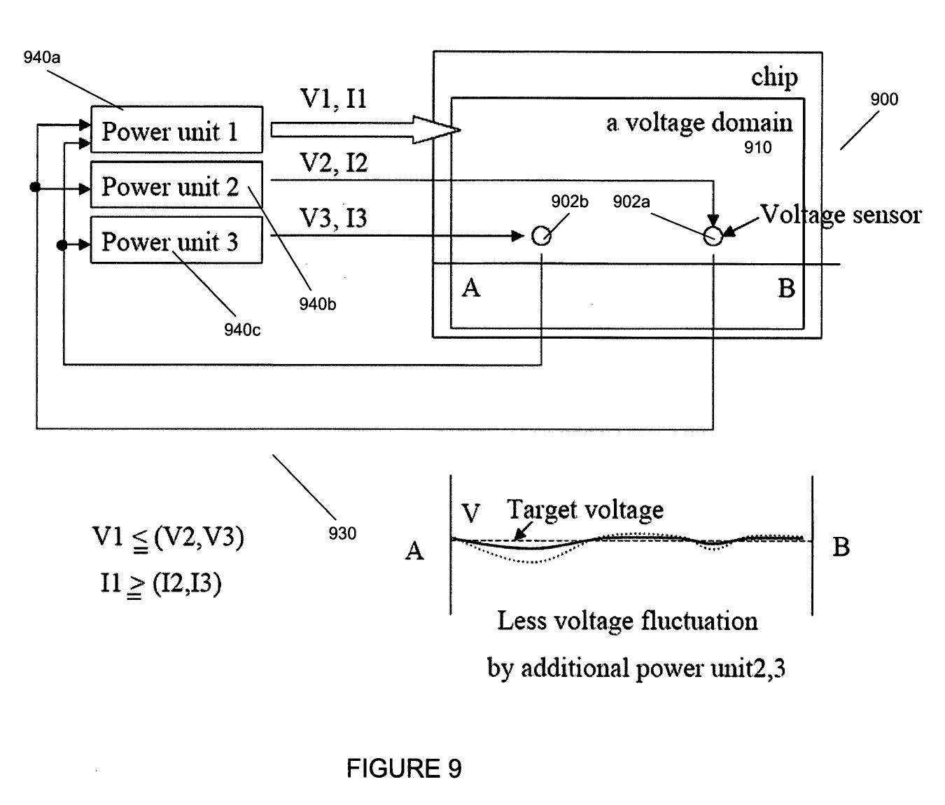

Turning to FIG. 9, one embodiment of just such a power distribution network is depicted. More specifically, semiconductor device 900 may comprise voltage domain 910 which, in turn, has voltage sensors 902. Power distribution network 930 comprises power supplies 940.

Power supply 940a (which may be a VRM as discussed above) may utilize a representative voltage for voltage domain 910 created through the processing of voltages sensed at voltage sensors 902 to deliver power to voltage domain 910 as discussed above. To help further control voltage fluctuations within voltage domain 910, however, power supply 940b may supply power to voltage domain 910 based on the voltage sensed at voltage sensor 902a while power supply 940c may supply power to voltage domain 910 based on the voltage sensed at voltage sensor 902b.

By coupling power supplies 940b, 940c in the vicinity of the respective voltage sensor 902a, 902b from which they are receiving a voltage signal, if the respective voltage sensor 902a, 902b indicated a voltage drop below the target voltage power can be supplied to that area (e.g. the area in the vicinity of that voltage sensor 902a, 902b) by the respective power supply 940b, 940c coupled to that area, commensurately reducing the voltage drop in that area and thus reducing the voltage fluctuation across voltage domain 910.

The radius within which power supplies 940b, 940c, or the portion of power distribution network 930 coupling power supplies 940b, 940c to the respective voltage sensor 902a, 902b, may vary depending on the degree of control desired in a given embodiment. For example, in one embodiment the portion of power network 930 coupling power supply 940c to voltage domain 910 may be within a radius of about 50-75 microns of voltage sensor 902b, while the portion of power distribution network 930 coupling power supply 940b to voltage domain 910 may be within a radius of about 50-75 microns of voltage sensor 902a. Other embodiments may utilize different distances, such as around −200 um or around −500 um among many others, depending on the particular embodiment.

Moreover, in one embodiment power supplies 940b, 940c may be smaller (e.g. may have less current capability but possibly supply higher voltages) than power supply 940a, as power supplies 940b, 940c may only need to supply enough power to compensate for relatively small voltage fluctuations, as opposed to power supply 940a which may be responsible for supplying the majority of power to voltage domain 910. For example, power supplies 940b, 940c may be capable of supplying about 10% of the current of power supply 940a, while power supplies 940b, 940c may be capable of supplying 10-80% higher voltage than power supply 940a, though the particular sizes of power supplies 940a, 940b, 940c and their relative sizes may vary depending on the embodiment desired.

As may be seen then, by reducing the size of power supplies 940b, 940c the impact of having additional power supplies 940b, 940c on cost and physical factors such as line width and the area of the package, and semiconductor device of the package, utilized for power supplies 940b, 940c may be reduced.

It will be apparent that differing numbers of voltage sensors, differing numbers of power supplies, differing sizes of power supplies and different coupling areas or methodologies may be utilized depending on the particular embodiment of the present invention utilized in a given circumstances. Furthermore, embodiments of the present invention may be utilized no matter the structure of a die comprising a semiconductor device die or a package comprising a semiconductor device. For example, a voltage domain in a semiconductor device may be supplied with voltage through one or more planes in a package to which the die comprising the semiconductor device is coupled.

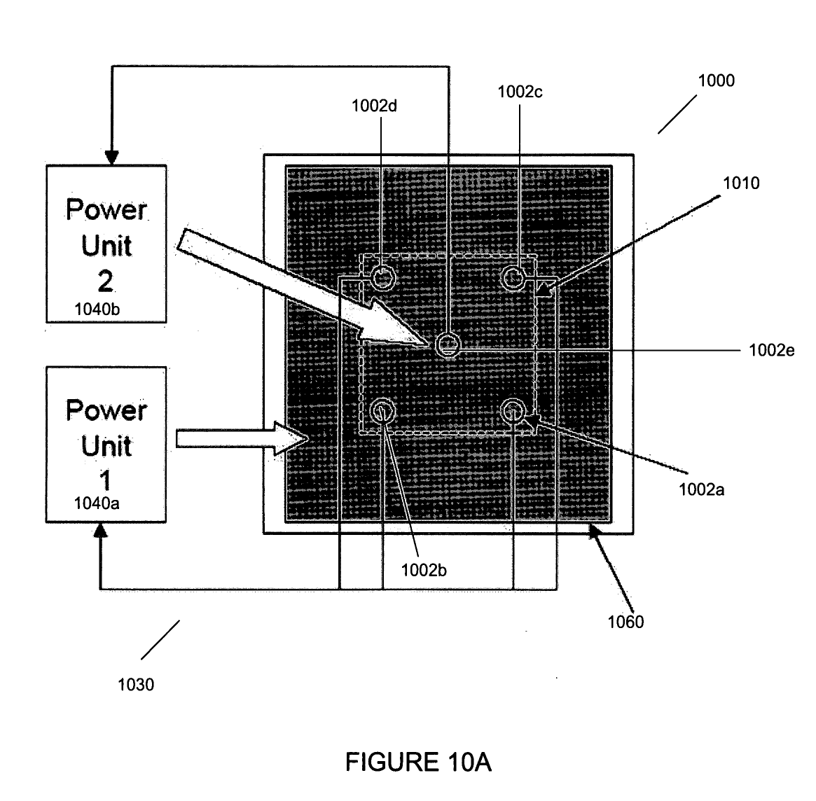

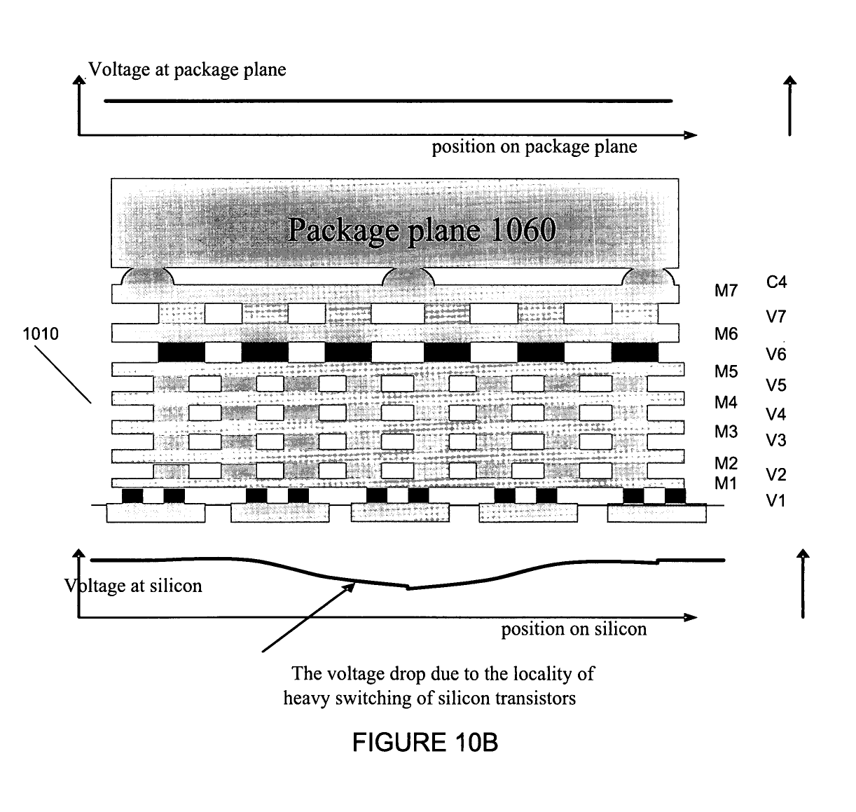

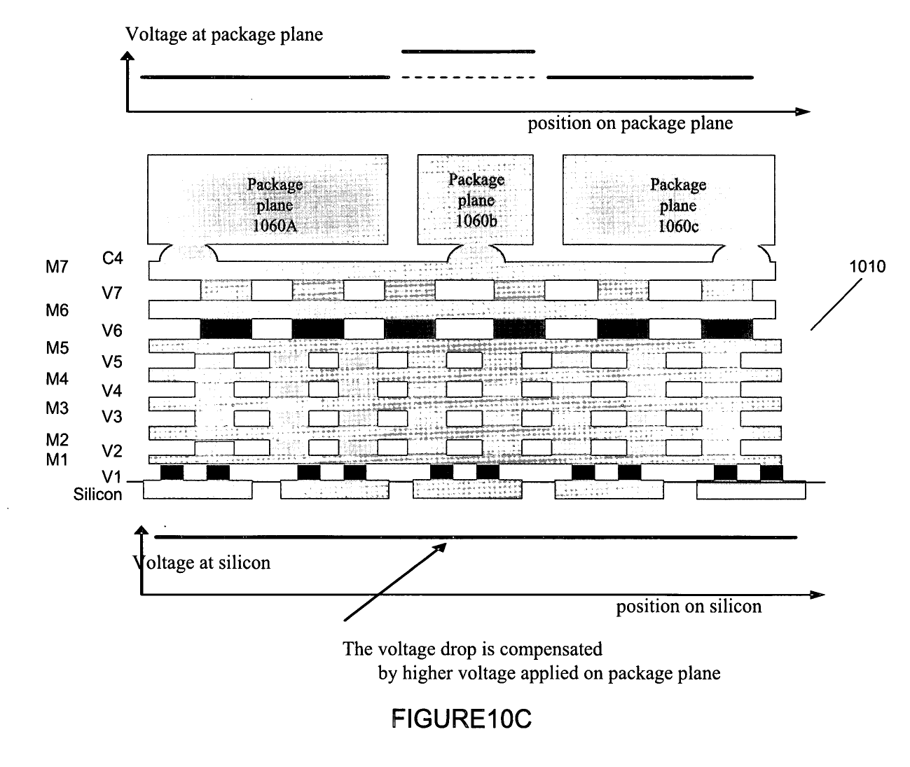

FIG. 10A depicts one embodiment of the present invention which may be utilized in the case where a single voltage domain is supplied with power from multiple power supplies through a plane of a package. More specifically, semiconductor device 1000 may comprise voltage domain 1010 which, in turn, has voltage sensors 1002. Power distribution network 1030 comprises power supplies 1040 coupled to voltage sensors 1002.

In one embodiment, power supply 1040a may utilize a representative voltage for voltage domain 1010 created through the processing of voltages sensed at voltage sensors 1002a, 1002b, 1002c and 1002d to deliver power to voltage domain 1010 as discussed above. To help further control voltage fluctuation within voltage domain 1010, however, power supply 1040b may supply power to voltage domain 1010 based on the voltage sensed at voltage sensor 1002e (which may not be coupled to power supply 1040a). Both power supplies 1040 may supply power to voltage domain 1010 through plane 1060 of a package comprising semiconductor device 1000 which includes voltage domain 1010.

For example, voltage domain 1010 may have a relatively high concentration of transistors in the center of voltage domain 1010 in the vicinity of voltage sensor 1002e. In one embodiment, by coupling power distribution network 1030 to voltage domain 1010 such that power unit 1040b supplies voltage in the vicinity of voltage sensor 1002e from which it is receiving a voltage signal, if the respective voltage sensor 1002e indicates a voltage drop below the target voltage power can be supplied to that area (e.g. the area in the vicinity of that voltage sensor 1002e) by power supply 1040b commensurately reducing the voltage drop in that area and thus reducing the voltage fluctuation across voltage domain 1010.

While the embodiment of the invention depicted in FIG. 10A has been described where power supply 1040a is the power supply and may operate based upon a representative voltage signal derived from voltage signals from voltage sensors 1002a, 1002b, 1002c and 1002d and power supply 1040b supplies power to voltage domain 1010 based on the voltage sensed at voltage sensor 1002e, it will be apparent after reading this disclosure that the opposite may be the case. More particularly, in one embodiment power supply 1040a may operate to supply power in the vicinity of voltage sensors 1002a, 1002b, 1002c and 1002d based upon voltages sensed at each of these voltage sensors 1002a, 1002b, 1002c and 1002d while power supply 1040b supplies power based on the voltage sensed at voltage sensor 1002e.

It will also be apparent that a variety of possibilities may be utilized in various embodiments with respect to when various power supplies 1040 supply power to voltage domain 1010. For example, power supplies 1040 may, during operation, both supply a target voltage to voltage domain 1010, with power supply 1040b supplying voltage above the target voltage if a voltage drop is detected at voltage sensor 1002. Alternatively, power supply 1040a may supply the target voltage to voltage domain 1010 during operation, with power supply 1040b only supplying extra power to voltage domain 1010 in the vicinity of voltage sensor 1002e when a voltage drop is detected at voltage sensor 1002e, etc.

In certain cases, however, if power is provided to a voltage domain through a single contiguous plane voltage drop in voltage domain 1010 may still be larger than is desired. This phenomenon may be explained better with reference to FIG. 10B, depicting the embodiment of FIG. 10A where power is supplied to voltage domain 1010 through package plane 1060 of power distribution network 1030, where package plane 1060 is contiguous. Here, every power supply 1040 in the power distribution network 1030 may be supplying power to voltage domain 1010 through package plane 1060. As can be seen, then, in this instance a relatively uniform distribution of voltage may exist throughout package plane 1060. As a consequence of this relatively uniform distribution of voltage throughout package plane 1060, power is substantially uniformly distributed from each of the power supplies 1040 throughout voltage domain 1010, which may leave voltage domain 1010 susceptible to voltage drop at any given time, for example because of a high locality of heavily utilized transistors in the middle of voltage domain 1010.

To remedy these types voltage drops, in one embodiment, a package plane may be divided into sections (which may wholly are partly separated from one another), such that power can be supplied from a power supply to an area of a voltage domain experiencing a voltage drop through a section of a package plane coupled in proximity to that area. Turning to FIG. 10C, one embodiment of supplying power to the embodiment of FIG. 10A, where power is supplied to voltage domain 1010 through multiple sections of a single plane is depicted. In this embodiment, plane 1060 comprises sections 1060a, 1060b, and 1060c. Power supply 1040a may be coupled to one or more of sections 1060a, 1060b or 1060c such that power unit 1040a can supply power to voltage domain 1010 through plane 1060. Power supply 1040b may be coupled to section 1060b such that power supply 1040b can supply power to voltage domain 1010 through section 1060b.

More specifically, in one particular embodiment, power supply 1040a may be coupled to voltage domain 1010 through sections 1060a and 1060c of package plane 1060, such that power supply 1040a can supply power to voltage domain 1010 thorough sections 1060a and 1060c based on the voltage sensed at voltage sensors 1002a, 1002b, 1002c and 1002d. Additionally, power supply 1040b may be coupled to section 1060b of package plane 1040b such that power supply 1040b can supply voltage to voltage domain 1010 through section 1060b.

Consequently, during operation of semiconductor device 1000 power supply 1040a may supply power to voltage domain 1010 based on the voltage sensed at voltage sensors 1002a, 1002b, 1002c and 1002d. If, during operation, a voltage drop below a target voltage is sensed at voltage sensor 1002e, power supply 1040b may supply power to voltage domain 1010. As power supply 1040b is coupled to section 1060b of package plane 1060 the power supplied from power supply 1040b may cause a higher voltage to exist in section 1060b of plane 1060 than in sections 1060a and 1060c. As section 1060c is coupled more closely to area in the vicinity of voltage sensor 1002e (e.g. the middle of voltage domain 1010) the power provided from power supply 1040b may serve to compensate for the voltage drop caused by the relatively higher activity or concentration of transistors in this area resulting in a more uniform voltage distribution throughout voltage domain 1010.

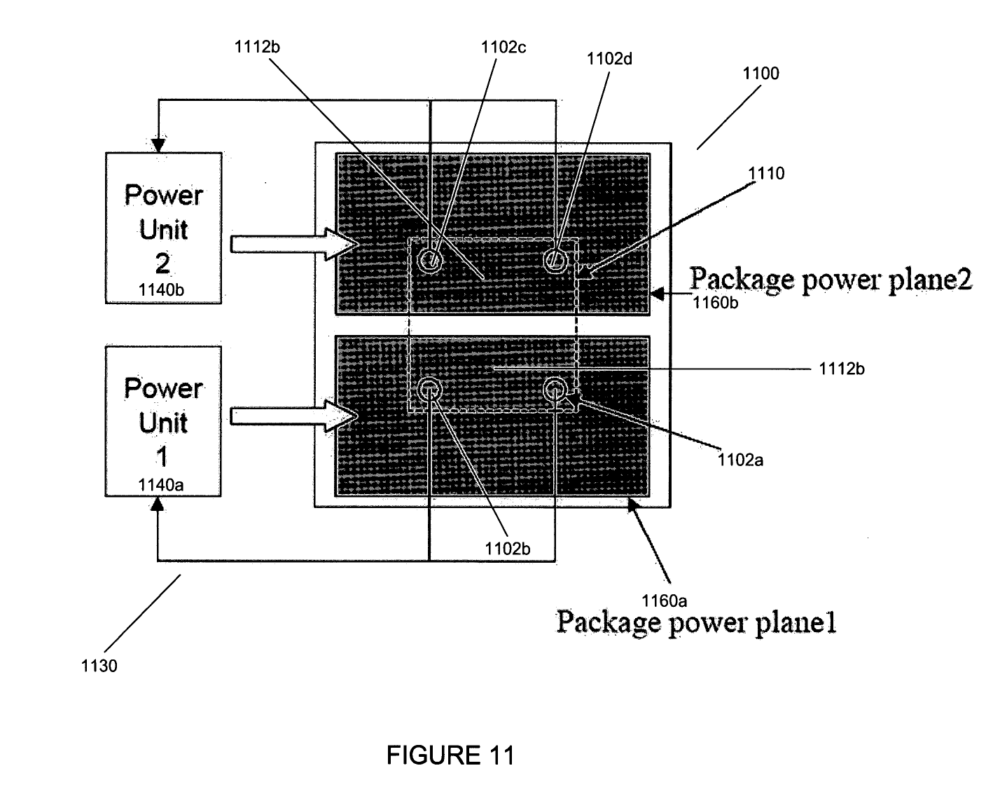

Turning now to FIG. 11, one embodiment of a power distribution network according to one embodiment of the present invention where power is supplied through multiple planes of a package is depicted. Here, semiconductor device 1100 may comprise voltage domain 1110 which, in turn, has voltage sensors 1102. Power distribution network 1130 comprises power supplies 1140 coupled to voltage sensors 1102.

In one embodiment, power supply 1140a may utilize a representative voltage created from voltages sensed at voltage sensors 1102a, 1102b to deliver power to voltage domain 1110 while power supply 1140b may utilize a representative voltage created from voltages sensed at voltage sensors 1102c, 1102d to deliver power to voltage domain 1110. Power supply 1140a may supply power to voltage domain through plane 1160a while power supply 1140b may supply power to voltage domain 1110 through plane 1160b. It will be apparent from the previous discussion with respect to FIGS. 10A, 10B and 10C that each of planes 1160a and 1160b may each be divided into multiple section and power provided from power supplies 1140a and 1140b through one or more of the sections of an associated plane 1160 (in fact, this observation may be applied to any of the subsequently discussed embodiments which refer to planes of a package).

Embodiments of the invention such as those depicted in FIG. 11 may be especially useful in preventing or ameliorating voltage fluctuations which may occur if a voltage domain encompasses different levels of a semiconductor die (e.g. which may be referred to as voltage fluctuations from south to north, where a northern area is farther from where a semiconductor device couples to a package relative to a southern area).

For example, with reference to FIG. 11, a portion 1112b of voltage domain 1110 may reside in a northern area of a semiconductor device while another portion 1112a of voltage domain 1110 may reside in a southern area (e.g. relative to the area in which portion 1112b resides). Power supply 1140a, may therefore supply voltage to voltage domain 1110. However, if power supply 1140a is solely used to supply to voltage domain 1110 through package plane 1160a this may result in a voltage fluctuation occurring in northern portion 1112b of voltage domain 1110 (as portion 1112b is further from the power source 1140a).

To remedy this situation, in one embodiment power supply 1140b may utilize voltage sensors 1102c and 1102d in the northern portion 1112b to provide additional voltage to voltage domain 1110. More specifically, in one embodiment, power supply 1140b may supply additional voltage (e.g. voltage which may be suitable to compensate for any difference between a target voltage and a voltage sensed at voltage sensors 1102c or 1102d) to voltage domain 1110 through a separate package plane 1160b which may be coupled more closely to northern portion 1112b of voltage domain 1110 than to southern portion 1112a such that the power supplied from power supply 1140b may better reach portion 1112b of voltage domain 1110 to substantially alleviate voltage fluctuations in voltage domain 1110 between northern portion 1112a and a target voltage. In embodiments such as these, power supplies 1140 may be of equal size (e.g. current capability) or power supply 1140a may be of greater size than power supply 1140b, as power supply 1140b may only be supplying additional voltage to voltage domain 1110.

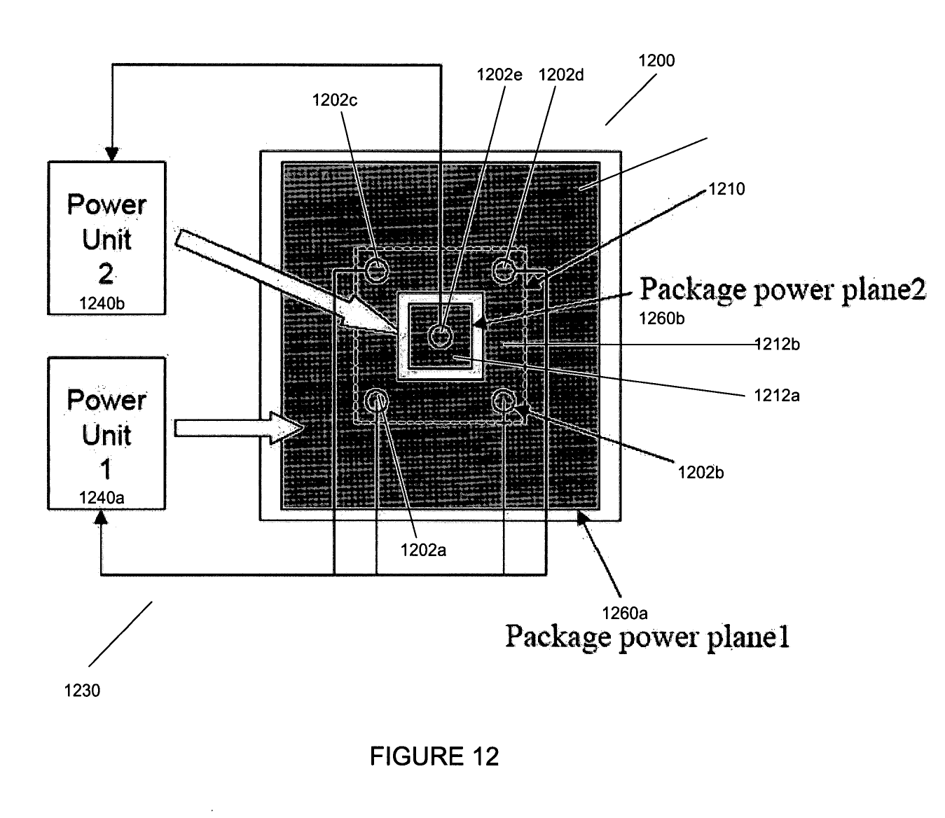

Similar techniques may be used in other embodiments of the present invention to deal with voltage fluctuations which may occur between portions of a voltage domain in other positions. For example, FIG. 12 depicts a power distribution network according to one embodiment of the present invention which may be useful in ameliorating voltage fluctuations which may occur between a center of a voltage domain and a periphery of the voltage domain.

In one embodiment, semiconductor device 1200 may comprise voltage domain 1210 which, in turn, has voltage sensors 1202. Power distribution network 1230 comprises power supplies 1240 coupled to voltage sensors 1202. Power supply 1140a may utilize a representative voltage created from voltages sensed at voltage sensors 1202a, 1202b, 1202c, 1202d (or one or more of voltages sensed at voltage sensors 1202a, 1202b, 1202c, 1202d) to deliver power to voltage domain 1210, while power supply 1240b may utilize a voltage sensed at voltage sensor 1202e to deliver power to voltage domain 1210. Power supply 1240a may supply power to voltage domain through plane 1260a while power supply 1240b may supply power to voltage domain 1210 through plane 1260b.

In certain cases, voltage fluctuations may occur between a portion 1212a substantially near the center of a voltage domain 1210 compared with the portion 1212b outside this center portion 1212a (e.g. a peripheral portion of voltage domain 1210). This voltage fluctuation may occur for a variety of reasons, for example circuits consuming relatively more power may be in center portion 1212a.

To remedy this type of situation, in one embodiment power supply 1240a may utilize voltage sensors 1202a. 1202b, 1202c and 1202d in the peripheral portion 1212b to provide voltage to voltage domain 1210, while power supply 1240b may utilize voltage sensor 1202e to provide additional voltage to substantially portion 1212a to compensate for voltage fluctuations occurring in voltage domain 1210. More specifically, in one embodiment, power supply 1240b may supply additional voltage (e.g. voltage which may be suitable to compensate for any difference between a target voltage and a voltage sensed at voltage sensor 1202e) to voltage domain 1210 through a package plane 1260b which may be coupled more closely to central portion 1212a of voltage domain 1210 than to peripheral portion 1212b such that the power supplied from power supply 1240b may better reach portion 1212a of voltage domain 1210 to substantially alleviate voltage fluctuations in voltage domain 1210 between central portion 1212a and a target voltage.

Again, the concepts discussed above with respect embodiments of the present invention may be applied to alleviate a whole host of problems which may result in voltage fluctuations in a voltage domain. In particular, a voltage domain may comprise areas of circuitry, such as processor cores, which may vary greatly in activity at any given time. Embodiments of the present invention may be utilized to deal with voltage fluctuations which may be caused by these variations in activity.

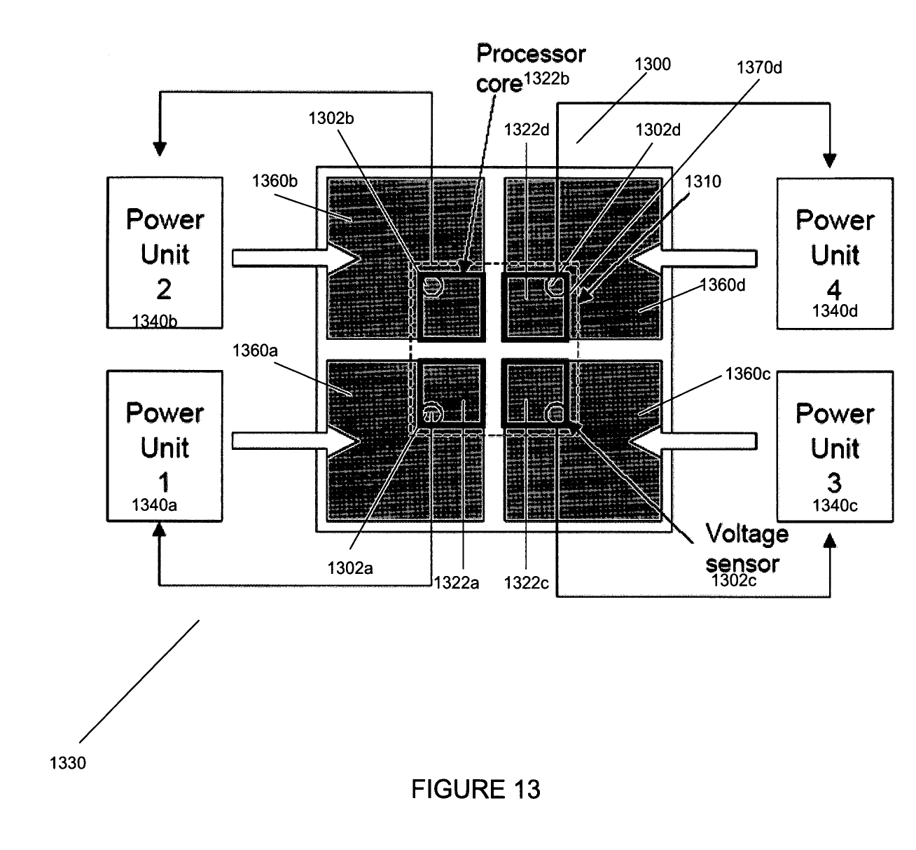

FIG. 13 depicts one embodiment of a power distribution network suitable to supply power to just such a voltage domain as the one discussed above. Semiconductor device 1300 may comprise voltage domain 1310 which, in turn, comprises a set of processor cores 1322. Each of processor cores 1322 may have a corresponding voltage sensor 1302 operable to sense the voltage in the area of the voltage domain 1310 near the voltage sensor 1302 (e.g. the corresponding processor core).

Power distribution network 1330 comprises power supplies 1340 coupled to voltage sensors 1302. Power supply 1340a may utilize a voltage sensed at voltage sensors 1302a to deliver power to voltage domain 1310, power supply 1340b may utilize a voltage sensed at voltage sensor 1302b to deliver power to voltage domain 1310, power supply 1340c may utilize a voltage sensed at voltage sensors 1302c to deliver power to voltage domain 1310 and power supply 1340d may utilize a voltage sensed at voltage sensor 1302d to deliver power to voltage domain 1310.

Each of power supplies 1340 may supply power to the voltage domain 1310 through a different plane 1360. For example, power supply 1340a may supply power to voltage domain 1310 through plane 1360a, power supply 1340b may supply power to voltage domain 1310 through plane 1360b, power supply 1340c may supply power to voltage domain 1310 through plane 1360c and power supply 1340d may supply power to voltage domain 1310 through plane 1360d.

Thus, during operation each of power supplies 1340 may supply a desired target voltage to voltage domain 1310. However, in some cases a certain processor core 1322 may become particularly active, causing a voltage fluctuation in, or near, the area of voltage sensor 1302 corresponding to that processor core 1322. In this case, based on the voltage sensed at that voltage sensor 1322 (which reflects the voltage fluctuation in the area) the power supply 1340 coupled to that voltage sensor 1302 may supply a higher voltage than the target voltage which may ameliorate the voltage fluctuations in voltage domain 1310.

In one embodiment, the plane 1360 through which the power supply 1340 supplies voltage to voltage domain 1310 may be coupled more closely to the area of voltage domain 1310 which comprises the corresponding voltage sensor 1302 and processor core 1322. Thus, when the power supply 1340 supplies a higher voltage than the target voltage, this higher voltage may serve to compensate for the high power consumption occurring in the area.

To illustrate more clearly, suppose processor core 1322d is particularly active and thus a voltage drop or fluctuation from the target voltage is sensed at voltage sensor 1302d. In this case, power supply 1340d may use the voltage sensed at voltage sensor 1302d to determine that a higher voltage than the target voltage should be supplied to voltage domain 1310 and this higher voltage supplied from power supply 1340d through plane 1360d. Plane 1360d may be coupled more closely to portion 1370d of voltage domain 1310 comprising processor core 1322d and voltage sensor 1302d and thus the power supplied from power supply 1340d may serve to compensate from the power consumed by processor core 1322d.

It will be apparent after a thorough reading of the specification that various depicted embodiments of the invention may be combined to greater or lesser efficacy depending on the particular embodiment of the invention desired. For example, referring to FIG. 13, a certain area 1322 supplied by a particular plane 1360 may in turn look akin to the embodiment of the invention depicted in FIG. 10. In other words, a particular area of a voltage domain supplied by a particular plane may in turn utilize a power distribution network (or portion of a power distribution network) that comprises multiple voltage sensors and power supplies utilized to compensate for voltage fluctuations within that particular area of the voltage domain. As may be realized myriad other combinations and permutations may also be implemented which come under the rubric of embodiments of the present invention.

In the foregoing specification, the invention has been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

What is claimed is:

1. A method, comprising:
sensing a voltage at each of a plurality of locations in a voltage domain; and
controlling power from a first power supply to the voltage domain based on the voltage sensed at the plurality of locations; and
controlling power from a set of second power supplies to the voltage domain, wherein each of the second power supplies is controlled based on a voltage sensed at one or more corresponding locations.

2. The method of claim 1, wherein each of the second power supplies provides less current than the first power supply.

3. The method of claim 1, wherein the plurality of locations comprises each of the one or more corresponding locations.

4. The method of claim 1, wherein the one or more corresponding locations are distinct from the plurality of locations.

5. The method of claim 1, wherein the power from the first power supply and power from the set of second power supplies is provided through a plane.

6. The method of claim 5, wherein power is provided from the second power supply substantially in the vicinity of the one or more corresponding locations.

7. The method of claim 6, wherein the power from the first power supplies is provided through a first section of the plane and power from each of the second power supplies is provided through a corresponding second section of the plane, where the second section is nearer the corresponding location than any other section of the plane.

8. The method of claim 1, wherein the power from the first power supply is provided through a first plane and the power from the set of second power supplies is provided through a second plane.

9. The method of claim 8, wherein power is provided from the second power supply substantially in the vicinity of the one or more corresponding locations.

10. The method of claim 9, wherein power from each of the second power supplies is provided through a corresponding section of the second plane, where the section of the second plane is nearer the corresponding location than any other section of the second plane.

11. A method, comprising:
controlling power from a set of power supplies to a voltage domain, wherein each of the power supplies is controlled based on a voltage sensed at one or more corresponding locations of a voltage domain, wherein each of the power supplies provides power to the voltage domain through a corresponding plane.

12. The method of claim 11, wherein the power is provided to the voltage domain in the vicinity of the corresponding location.

13. The method of claim 12, wherein each corresponding location comprises a processor core.

14. A system, comprising:
a semiconductor die having a voltage domain and a plurality of voltage sensors;
a first power supply operable to provide power to the voltage domain, wherein the power provided from the first power supply to the voltage domain is controlled based on the voltages sensed at the plurality of voltage sensors;
a set of second power supplies operable to provide power to the voltage domain, wherein the power provided from each of the second power supplies is controlled based on the voltage sensed at one or more corresponding locations.

15. The system of claim 14, wherein each of the second power supplies is operable to provide less current than the first power supply.

16. The system of claim 14, wherein the plurality of locations comprises each of the one or more corresponding locations.

17. The system of claim 14, wherein the one or more corresponding locations is distinct from the plurality of locations.

18. The system of claim 14, further comprising,
a plane, wherein the power from the first power supply and power from the set of second power supplies is provided through the plane.

19. The system of claim 18, wherein power is provided from the second power supply substantially in the vicinity of the one or more corresponding locations.

20. The system of claim 19, wherein the plane comprises a set of sections the first power supply coupled to a first section of the plane and each of the second power supplies is coupled to a corresponding second section of the plane, where the second section is nearer the corresponding location than any other section of the plane.

21. The system of claim 14, further comprising
a first plane, wherein the power from the first power supply is provided through the first plane, and
a second plane, wherein power from the set of second power supplies is provided through the second plane.

22. The system of claim 21, wherein power is provided from the set of second power supply substantially in the vicinity of the one or more corresponding locations.

23. The system of claim 22, wherein each of the second power supplies is coupled to a corresponding section of the second plane, where the corresponding section of the second plane is nearer the corresponding location than any other section of the second plane.

24. A system, comprising:
a semiconductor die having a voltage domain and a plurality of voltage sensors, each of the voltage sensors in a corresponding location of the voltage domain;
a set of power supplies; and
a set of planes, each plane coupled to a corresponding power supply and operable to provide power from the corresponding power supply to the voltage domain, wherein the power provided from the corresponding power supply is controlled based on a voltage sensed at the voltage sensor in the corresponding location.

25. The system of claim 24, wherein the corresponding plane is configured to provide power to the voltage domain in the vicinity of the corresponding location.

26. The system of claim 25, wherein each corresponding location comprises a processor core.
